(19) United States
(12) Patent Application Publication
(10) Pub. No.: US 2008/0162101 A1
(43) Pub. Date: Jul. 3, 2008

(54) Method for Predicting the State of the Gastric Mucosa

(75) Inventors: Seppo Sarna, Espoo (FI); Tapani Tiusanen, Vantaa (FI); Osmo Suovaniemi, Helsinki (FI)

Correspondence Address: BIRCH STEWART KOLASCH & BIRCH, PO BOX 747, FALLS CHURCH, VA, 22040-0747, US

(73) Assignee: Biohit Oyj, Helsinki (FI)

(21) Appl. No.: 10/598,606

(22) PCT Filed: Mar. 3, 2005
(86) PCT No.: PCT/FI2005/050061

§ 371 Date: Dec. 14, 2006

(30) Foreign Application Priority Data
Mar. 5, 2004 (FI) 20040359

(51) Int. Cl. G06G 7/60

(52) U.S. Cl. 703/11

(57) ABSTRACT

The present invention is directed to a method for assessing or predicting the state of the gastric mucosa in a subject by determining, in said subject, the probability for the gastric mucosa belonging to at least one gastric mucosa class, the method comprising: measuring, from a sample of said subject, the pepsinogen I (PGI) and gastrin-17 (G-17) analyte concentrations, as well as determining the presence or concentration of a marker for Helicobacter pylori; entering the data so obtained in a data processing system comprising an operating system, a database and means for transceiving and processing data, the said data processing system being adapted to determine the probability for the gastric mucosa belonging to the at least one gastric mucosa class, based on the data entered as well as on predefined clinical data in the database, the information so generated being indicative of the state of the gastric mucosa in said subject.

### FIELD OF THE INVENTION

The present invention is directed to a method for assessing or predicting the state or condition of the gastric mucosa, by determining the probability for the gastric mucosa of a subject belonging to at least one gastric mucosa class or category. In the method, the concentration of specific mucosa specific analytes, such as the pepsinogen I concentration, the gastrin-17 concentration as well as the concentration or presence of a Helicobacter pylori marker, is determined in the subject, and data processing means are used to determine the probability for the gastric mucosa of the subject belonging to the at least one gastric mucosa class or category.

### BACKGROUND OF THE INVENTION

Although the occurrence of new cases of gastric cancer has diminished in the recent years, gastric cancer is still one of the most common malignancies. In Finland, appr. 250 to 300 new cases of cancer/one million people/year are registered. In the age group of people above 50, there are an estimated 2350 cases of stomach cancer, which is about 3 per mille of the age group population (Finnish Cancer Registry—The Institute for Statistical and Epidemiological Cancer Research 1993). In addition to Finland, there is a high gastric cancer incidence in Iceland, South America and especially in Japan and China.

The prognosis of gastric cancer is usually poor, as there is no specific treatment. Presently the only possibility of successfully treating gastric cancer is its early detection and total removal surgically.

Gastric cancer does not necessarily give any symptoms in its early stages. The late appearance of symptoms naturally delays the patient from seeking treatment. On the other hand, the clinical findings in the early stage of gastric cancer are often non-specific. The primary diagnostic method for gastric cancer is presently gastroscopy and biopsies, cell and aspiration cytology associated therewith. As routine gastroscopies are carried out in order to examine symptoms, such as pain in the upper abdomen or bleeding of the gastrointestinal tract, a symptomatic gastric cancer discovered in this manner is often already far advanced and thus inoperable. Attempts have also been made at improving primary diagnostics with various immunological methods, but no sufficiently specific immunological method has been successfully developed.

It is a primary object to find the means by which it would be possible to identify within the general population easily and with moderate costs those persons which might be suffering from gastric cancer in its initial stages. After identification these persons should immediately be examined by gastroscopy. At the same time those persons could be identified which exhibit premalignant gastric changes which need to be followed up.

Gastric cancer can be preceded by a number of different gastric diseases or conditions (so called precancerous conditions), which are chronic atrophic gastritis, pernicious anaemia, ventricular ulcer, gastric polyposis and the Menetrier disease (giant hypertrophic gastritis). Clearly identifiable changes of the mucosa are dysplasia and adenoma. The said conditions are associated with an appr. 4 to 5 fold relative cancer risk, as compared to the general population. It has been established that in almost all diseases the risk is mediated over chronic atrophic gastritis.

Chronic gastritis means a prolonged inflammatory condition of the gastric mucosa. The disease can coarsely be divided into the so-called superficial and the atrophic form. In superficial gastritis, the inflammatory cell infiltration is concentrated below the surface epithelium. In case the inflammation progresses and diffuses between the specific gastric secretory glands, one refers to chronic atrophic gastritis. In such a case, the normal glandular structures of the gastric mucosa are at least partly substituted by metaplastic changes.

The relative risk of gastric cancer in patients suffering from atrophic gastritis in the corpus area of the stomach, has been estimated, as calculated from the Finnish cancer statistics, to be about 4- to 5-fold as compared to persons having a healthy mucosa. In addition, there is a risk for falling ill with pernicious anaemia due to intrinsic factor deficiency and B12 vitamin absorption disturbance. In severe atrophy of the antrum area, the risk is even 18-fold. If atrophic changes appear both in the antrum and the corpus area (pangastritis), the risk can increase to even 90-fold (Sipponen, P, Kekki, M, Haapakoski, J. Ihamaki, T & Siurala, M (1985) Gastric cancer risk in chronic atrophic gastritis: statistical calculations of cross-sectional data. Int J Cancer 35:173-77).

Helicobacter pylori is a spiral shaped, gram-negative bacterium which thrives in the mucus in the immediate vicinity of the surface epithelial cells of the gastric mucosa and in the cell interstices. The bacterium apparently is transmitted perorally from one person to the other. The effect of the bacterium on the gastric mucosa is an inflammation reaction, which is mediated over a complement by liberating strong inflammation mediator substances. After the acute stage, the inflammation is transformed into chronic gastritis. In patients suffering from chronic gastritis, in 70 to 90% a Helicobacter pylori infection can be established (Calam, J (1994) Helicobacter pylori (Review) Eur. J. Clin Invest 24: 501-510). As Helicobacter pylori infection and chronic gastritis in the stomach are closely associated, it has been stipulated that this bacterial infection could be one etiological factor in the development of stomach cancer. It is for this reason possible that eradication of the Helicobater pylori bacteria in the initial stages of the infection, could prevent the development of atrophy associated with chronic gastritis, and thus reduce the cancer risk and the risk of peptic ulcers.

The publication WO 96/15456, which is included herein for reference, discloses a method for screening for the risk of cancer by determining the concentration of the analytes pepsinogen I, and gastrin-17 from a serum sample of a subject. According to the said publication, the so determined concentration values are then compared to a cut-off value and a reference value for each analyte. A serum pepsinogen I concentration below the cut-off value for pepsinogen I in combination with a gastrin-17 concentration value above the upper reference limit indicates severe atrophy of the corpus area of the stomach. A serum gastrin-17 level below the cut-off value for gastrin-17 in combination with a pepsinogen I value above the cut-off value for pepsinogen I on the other hand indicates atrophy of the antrum area of the stomach. In case the serum pepsinogen I is below the cut-off value for pepsinogen I, and the gastrin-17 level is at the lower limit of its reference value, this is an indication of severe atrophy in the whole stomach, i.e. of atrophic pangastritis. According to an embodiment disclosed, the said tests may be combined with a test for Helicobacter pylori antibodies.

According to the said WO-publication, the method can be supplemented with a so-called protein stimulation test, according to which a blood sample is taken in the morning after fasting, whereafter the patient eats a protein-rich standard meal and blood samples are taken at 15 minute intervals for two hours. The maximal increase is evident after appr. 20 minutes. In case the atrophy is located in the antrum, there will be a strongly reduced response in this test. When the atrophy is located in the corpus, the response will be normal or increased, whereas atrophy of the whole mucosa leads to a reduced response.

The WO-publication WO 00/67035, which is included herein for reference, discloses a method for assessing the risk of peptic ulcer by determining quantitatively the concentration of serum pepsinogen I and serum gastrin-17. According to this method, if both the measured serum pepsinogen I and gastrin-17 values are high, above the upper limit of their respective reference values, or the serum pepsinogen I value is above the upper limit of its reference value in combination with a gastrin-17 value within the reference range or below its cut-off value, this is an indication of an increased risk of peptic ulcer.

Methods are known in the art for measuring the concentrations of the various analytes, and there are also commercially available kits for this purpose. Some exemplatory methods for carrying out the said determinations are described in the WO-publication 96/15456 as well.

### SUMMARY OF THE INVENTION

The object of the invention is a method for assessing or predicting the state of the gastric mucosa in a subject by determining, in said subject, the probability for the gastric mucosa belonging to at least one gastric mucosa class, the method comprising
measuring, from a sample of said subject, the pepsinogen I (PGI) and gastrin-17 (G-17) analyte concentrations, as well as determining the presence or concentration of a marker for Helicobacter pylori,
entering the data so obtained in a data processing system comprising an operating system, a database and means for transceiving and processing data, the said data processing system being adapted to determine the probability for the gastric mucosa belonging to the at least one gastric mucosa class, based on the data entered as well as on predefined clinical data in the database, the information so generated by the data processing system being indicative of the state of the gastric mucosa in said subject.

According to the invention the generated information can thus be used for the assessment or the prediction of the state of the gastric mucosa in said subject.

The invention is also directed to a kit and to a computer program product especially for use in the method according to the invention.

The kit according to the invention comprises means for determining, from a sample, the pepsinogen I and gastrin-17 concentration, and the concentration or presence of a Helicobacter pylori marker, as well as a computer program product embodied on a computer readable medium and comprising computer code means adapted to determine a probability for a gastric mucosa class, based on measured values for said analytes and/or marker, as well as predefined clinical data in a database, and to provide information in response to said determination and optimally to other entered data, when run on a computer.

The computer program product according to the invention is embodied on a computer readable medium and comprises computer code means adapted to determine a probability for a gastric mucosa class, based on measured values for the PGI and G-17 analytes and Helicobacter pylori marker, as well as predefined clinical data in a database and to provide information in response to said determination and optionally to other entered data, when run on a computer.

### DETAILED DESCRIPTION OF THE INVENTION

In this invention, the term “probability for a gastric mucosa class” means the probability for the gastric mucosa of the subject to be tested to belong in a gastric mucosa class.

The term “gastric mucosa class” of a subject refers to the gastric mucosa of a subject being classified as being normal (N), exhibiting superficial or non-atrophic gastritis (S), corpus atrophy (C), antrum atrophy (A), or antrum+corpus atrophy (AC), respectively. The invention makes it possible to determine the probability of the subject's stomach of belonging to one or more of the said classes, and/or to determine the probability distribution of a number of classes.

In the present invention, the clinical database comprises data obtained from gastroscopic studies and biopsy, corresponding concentrations for mucosa specific analytes and/or markers, optionally other data entered, and information on different classes to predict. The probabilities are preferably determined using a statistical method, and the preferred statistical method for calculating classification probabilities is the multinominal logistic regression method. The predefined clinical data in the database comprises data obtained from a reference population group by gastroscopic study and determination of the PGI and G-17 analytes and Helicobacter pylori marker in said reference population group.

According to the present invention the Helicobacter pylori marker is a Helicobacter pylori antibody, the concentration of which is measured from a sample or the Helicobacter pylori antigen, the presence of which is determined in the sample. The gastrin value that is measured is the stimulated gastrin-17 value (G-17st), or both the fasting (basal) gastrin-17 and the stimulated gastrin-17.

In one embodiment of the invention, in addition, the concentration of the analyte pepsinogen II (PGII) is measured, and the ratio PGI/PGII is used in the statistical calculation.

According to the invention the analytes are measured from a body fluid, such as a serum whole blood, urine, saliva or lacrimal fluid sample, especially a serum sample.

According to one embodiment of the invention, the generated information advantageously relates to at least one gastric mucosa class probability, whereby an estimate of the change in the said probability can be used to provide information as to the change in the state of the gastric mucosa.

The data processing means can comprise a display on which the generated information is displayed.

The basic statistical method used in the invention to classify the gastric mucosa is based on stochastic multinominal logistic regression analysis (MLR) run on clinical data. The benefit of a stochastic version compared to a simpler deterministic approach, where a value is rated based on a simple cut-off analysis, is that it relies on the fact that stochastic models consider uncertainty as an important aspect of the problem. This means that the stochastic approach is less insensitive to different kinds of errors and random variation, which do exist in a complex process like this and is clearly the preferred method to use.

Logistic regression is preferred over linear because it solves the problems related to the “classical regression assumptions” i.e. heteroskedasticity of error terms, normal distribution requirement and negative (or >1) probabilities. This means that the logistic regression is often preferred because it does not require a linear relationship between the dependent and independent variables, which is the case with most clinical assays, where the relationship typically follows an S-shaped curve.

Multinominal logistic regression is used where there are several dependent variables, in the case of the invention gastric mucosa classes. A general multinominal logistic regression model is presented as follows:

ln(P/1−P)=BX+E,

wherein,
P is a vector (n×1) containing the response variable (class probability)
B is a vector (q×1) containing the model parameters
X is a matrix (n×q) containing the q factors
E is a vector (n×1) containing the noise terms
wherein n is the number of classes and q is the number of parameters.

Prior to creating the models the values for the coefficients Bⱼ are calculated using the maximum likelihood estimates method of the different classes from clinical data in a database.

As the different classes of gastric mucosa are predefined, each combination of independent variables generates different coefficients of Bⱼ. Therefore, a model based method for estimating probabilities requires several models covering all the possible combinations of entered data. If the combination is limited, and if the database is statistically big enough, this is the preferred method of choice due to its computational simplicity.

If the database is statistically small and there is an obviously clear unbalance between the data available for the different classes, a combination of parameters may gain better estimates than the others. Two variants of the possible modification of the model-based method are presented here. An “iterative method” uses all the parameters entered for the first probability estimates. Depending on the outcome, it automatically uses a subset of entered parameters for new calculation of probability estimates. A “permutative method”, on the other hand, uses all the different model permutations to calculate probability estimates to find out the most probable class for the entered parameters.

If the database is statistically small or dynamic in nature and the data processing system is fast enough, the probability estimates can be calculated using the maximum likelihood estimates on the entered data in real time.

Either the model parameters or especially the database can be located at a distance from the data processing system calculating the probabilities for the entered data.

In case of a remote database it is practical to set up a database server with a server based application re-running the models every time new clinical data is entered to the clinical database. The remote client application where parameters are entered fetches the model parameters from the remote database server for probability calculations. It is obvious that Internet technology provides the information highway for the data transmission between the client and the server systems.

According to the invention, the continuous probability value as a parameter provides means for detecting a change of state of classes in question. By resampling the patient at a later time, information on probability development with time enables better diagnosis or a suggestion for treatments or further investigations and/or tests based on the results so obtained.

The clinical data is collected by assaying patients and by classifying patients stomachs in different groups, whereby the gastric mucosa classes N=normal antrum, S=superficial, C=Corpus atrophy, A=Antrum atrophy, AC=Antrum+Corpus atrophy are obtained, based on gastroscopy and biopsy studies.

A statistical run is then performed to find out constants for the different models. A model based application program uses the predefined models to calculate probabilities for the different classes (N, S, C, A, AC) on the parameters entered.

If the result indicates a non-normal case with a present helicobacter infection, treatment is started. After a period of time (e.g. 3 months) a new assaying can be performed. By comparing the probability distribution to the earlier ones, a treatment result can be predicted.

The suggested diagnosis provided is based on the maximum likelihood estimates of the most probable gastric mucosa class on the measured assay levels. The diagnosis of the most probable case displayed is hardly ever 100% probable, but rather much lower, but still higher than any other option. In fact the stochastic version displays these probabilities to every gastric mucosa class to view the difference. It can then easily be seen what the probability is for healthy vs. abnormal values. The probability distribution provides important information for doctors not only in suggesting a diagnosis but also in guiding for re-test or further investigations.

As the presented stochastic method provides for the most probable gastric mucosa class, it offers one more benefit over a deterministic model. As soon as treatment e.g. eradication therapy for Helicobacter pylori has been carried out, a blood sample can easily be taken 3 to 6 months later and simple and non-expensive serological assays be carried out. By following the assay levels, and especially the predicted probabilities, a possible healing can be detected by simply plotting the probabilities vs. time or by using a mathematical method on time series to predict a change of state.

In one preferred embodiment of the invention the maximum likelihood estimate calculations for classification probabilities based on entered analyte or marker data can be done at the same time on the existing database or by using pre-calculated multinominal regression models run earlier on a clinical database.

According to one embodiment of the invention a series of measurements with classification probabilities are combined which enables that information of a change, e.g. healing of the stomach mucosa, can be predicted.

In assessing the change in the state of the gastric mucosa over time, the probability for the at least one gastric mucosa class is re-determined, at a later point of time, and the probabilities so calculated are compared in order to estimate a change in the said probabilities and to provide information relating to the change in the state of the gastric mucosa.

The generated information is advantageously used to generate a diagnosis or a suggestion for treatment or further investigations and/or tests.

The following examples are intended to illustrate the invention without restricting it in any way. The analytes measured are pepsinogen I, gastrin-17 and Helicobacter pylori antibodies. The probabilities for each gastric mucosa category are determined by multinominal logistic regression. Also the respective diagnosis is given in each example, together with further suggestions for examinations and treatments, when applicable.

### EXAMPLE 1

The following analyte concentrations were measured from a sample of a patient.

| | | |
|---|---|---|
| Pepsinogen I | 7 | μg/l |
| Gastrin-17 (post pr.) | 49.9 | pmol/l |
| H. pylori lgG: | 156 | EIU |

Based on the concentrations determined, the following probabilities were calculated.

### Probabilities:

| | |
|---|---|
| NORMAL | 0.2% |
| ANTRUM ATROPHY | 0% |
| ANTRUM AND CORPUS ATROPHY | 19% |
| CORPUS ATROPHY | 66.7% |
| NON-ATROPHIC GASTRITIS | 13.8% |

Based on the calculated probabilities a diagnosis of atrophic corpus gastritis is suggested. Such a diagnosis is associated with:
1. Increased risk of gastric cancer (risk factor 5×).
2. Peptic ulcer disease (duodenal or gastric) is unlikely.
3. Helicobacter pylori infection.

### EXAMPLE 2

The following analyte concentrations were measured from a sample of a patient.

| | | |
|---|---|---|
| Pepsinogen I | 87 | μg/l |
| Gastrin-17 | 0.3 | pmol/l |
| H. pylori lgG: | 12 | EIU |

Based on the concentrations determined, the following probabilities were calculated.

### Probabilities:

| | |
|---|---|
| NORMAL | 84.5% |
| ANTRUM ATROPHY | 6.2% |
| ANTRUM AND CORPUS ATROPHY | 0% |
| CORPUS ATROPHY | 0.1% |
| NON-ATROPHIC GASTRITIS | 8.9% |

Based on the calculated probabilities a diagnosis of a normal mucosa is suggested. Such a diagnosis is associated with:
1. Very low risk of gastric cancer.
2. Very low risk of peptic ulcer.
3. No Helicobacter pylori infection.

### EXAMPLE 3

The following analyte concentrations were measured from a sample of a patient.

| | | |
|---|---|---|
| Pepsinogen I | 7 | μg/l |
| Pepsinogen II | 3 | μg/l (PGI/PGII: 2.3) |
| Gastrin-17 | 20 | pmol/l |
| H. pylori lgG: | 48 | EIU |

Based on the concentrations determined, the following probabilities were calculated.

### Probabilities:

| | |
|---|---|
| NORMAL | 2.6% |
| ANTRUM ATROPHY | 1.9% |
| ANTRUM AND CORPUS ATROPHY | 16.1% |
| CORPUS ATROPHY | 73.5% |
| NON-ATROPHIC GASTRITIS | 5.6% |

Based on the calculated probabilities a diagnosis of atrophic corpus gastritis is suggested. Such a diagnosis is associated with:
1. Increased risk of gastric cancer (risk factor 5×).
2. Peptic ulcer disease (duodenal or gastric) is unlikely.
3. Helicobacter pylori infection.

### EXAMPLE 4

The following analyte concentrations were measured from a sample of a patient.

| | | |
|---|---|---|
| Pepsinogen I | 11.5 | μg/l |
| Pepsinogen II | 1.6 | μg/l (PGI/PGII: 7.1) |
| Gastrin-17 | 33.1 | pmol/l |
| H. pylori lgG: | 26.9 | EIU |

Based on the concentrations determined, the following probabilities were calculated.

### Probabilities:

| | |
|---|---|
| NORMAL | 25.6% |
| ANTRUM ATROPHY | 6.9% |
| ANTRUM AND CORPUS ATROPHY | 5.5% |
| CORPUS ATROPHY | 49.3% |
| NON-ATROPHIC GASTRITIS | 12.4% |

Based on the calculated probabilities a diagnosis of atrophic corpus gastritis is suggested. Such a diagnosis is associated with:
1. Increased risk of gastric cancer (risk factor 5×).
2. Peptic ulcer disease (duodenal or gastric) is unlikely.
3. No Helicobacter pylori infection—atrophic gastritis probably autoimmune in origin.

### EXAMPLE 5

The following analyte concentrations were measured from a sample of a patient.

| | | |
|---|---|---|
| Pepsinogen I | 14.2 | μg/l |
| Pepsinogen II | 1.7 | μg/l (PGI/PGII: 8.3) |
| Gastrin-17 | 21.7 | pmol/l |
| H. pylori lgG: | 27 | EIU |

Based on the concentrations determined, the following probabilities were calculated.

### Probabilities:

| | |
|---|---|
| NORMAL | 38.2% |
| ANTRUM ATROPHY | 7.5% |
| ANTRUM AND CORPUS ATROPHY | 5.7% |
| CORPUS ATROPHY | 33.1% |
| NON-ATROPHIC GASTRITIS | 15.2% |

Based on the calculated probabilities a diagnosis of a normal mucosa is suggested. Such a diagnosis is associated with:
1. Very low risk of gastric cancer.
2. Very low risk of peptic ulcer.
3. No Helicobacter pylori infection.

### EXAMPLE 6

The following analyte concentrations were measured from a sample of a patient.

| | | |
|---|---|---|
| Pepsinogen I | 14.7 | μg/l |
| Pepsinogen II | 2.2 | μg/l (PGI/PGII: 6.6) |
| Gastrin-17 | 24.2 | pmol/l |
| H. pylori lgG: | 25.7 | EIU |

Based on the concentrations determined, the following probabilities were calculated.

Probabilities:

| | |
|---|---|
| NORMAL | 30.6% |
| ANTRUM ATROPHY | 6.2% |
| ANTRUM AND CORPUS ATROPHY | 6.3% |
| CORPUS ATROPHY | 42.9% |
| NON-ATROPHIC GASTRITIS | 13.9% |

Based on the calculated probabilities a diagnosis of atrophic corpus gastritis is suggested. Such a diagnosis is associated with:
1. Increased risk of gastric cancer (risk factor 5×).
2. Peptic ulcer disease (duodenal or gastric) is unlikely.
3. No Helicobacter pylori infection—atrophic gastritis probably autoimmune in origin.

The agreement with the reference method, i.e. gastroscopy and biopsy, is dependent on the gastric mucosa class and the model used. The overall agreement using a model with PGI, PGII, G17st and HPab is 80.2%. For class N, a normal healthy mucosa, the overall agreement is 90.8%. For corpus atrophy (C) and non-atrophic gastritis (S) the result is 85.5% and 74.0% respectively. The corresponding values for classes A and AC are somewhat lower, as these classes are more difficult to predict.

It has also been shown in tests that the highest class so predicted corresponds to the same gastritis class finding with gastroscopy with a much higher percentage. E.g. if the most probable class is predicted with a probability of 65%, the same class finding with gastroscopy is achieved in 90% of the cases. Therefore, if the most probable class is predicted with over 90% probability, there is practically a one-to-one correspondence with gastroscopy and biopsy.

### BRIEF DESCRIPTION OF THE DRAWINGS

In FIG. 1 the classification probability for the patient according to Example 1, whereby the first assay results for PGI and G17 relate to the values given in Example 1, as a function of time is presented for the different classes (N, A, AC, C, S). Five sets of assays were made during a period of two years. The patient was treated to eradicate Helicobacter. It can bee seen that when treatment is put in, the probability for corpus gastritis is decreasing, after 3 months the probability having decreased from 70% to 50% and after 8 months it is about 33%. Also the probability for corpus and antrum gastritis has decreased from 20% to around 5% during the same time. The probability for a normal healthy mucosa has in this time increased from almost 0% to almost 40%.

FIG. 2 is a graphical illustration, a probability ‘map’, generated from the quantitative probability values for the different gastric mucosa classes. In case of three quantitative marker values, each point in the space represents the most probable class and its probability value. The present FIG. 2 displays a case where G-17 is set to 3 μmol/l, providing a two dimensional presentation of the map with PGI and HP-ab as the axes. From the figure, by inserting the measured values for PGI and HPab into the coordinate system, it can be seen which of the classes (A, AC, C, S, N) is the most probable. If the point is situated far from other class regions (A, AC, C, S, N), the probability for that class is high, if the point is situated close to the border to another region, the result is more uncertain, and another possible class need to be considered.

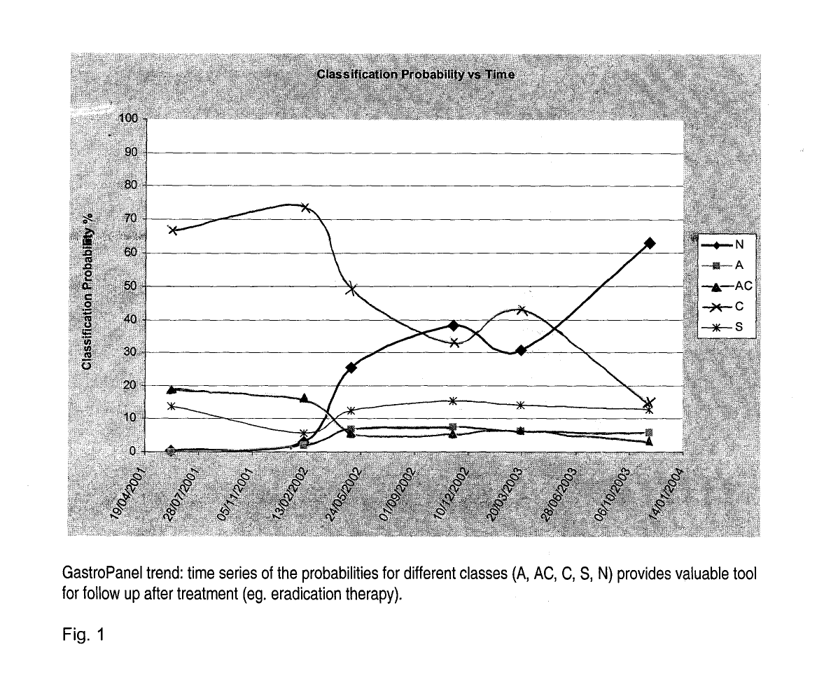

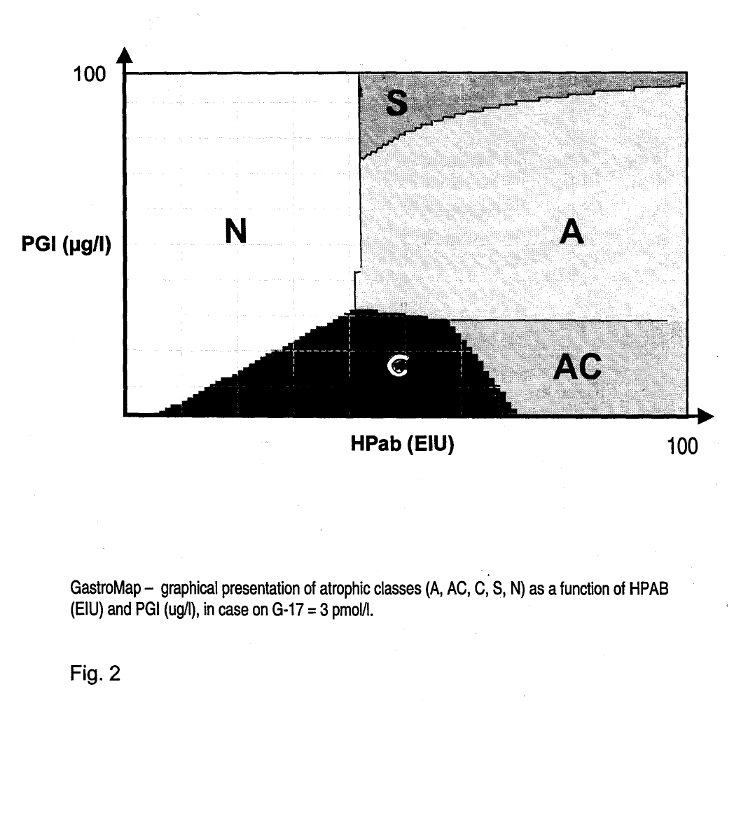

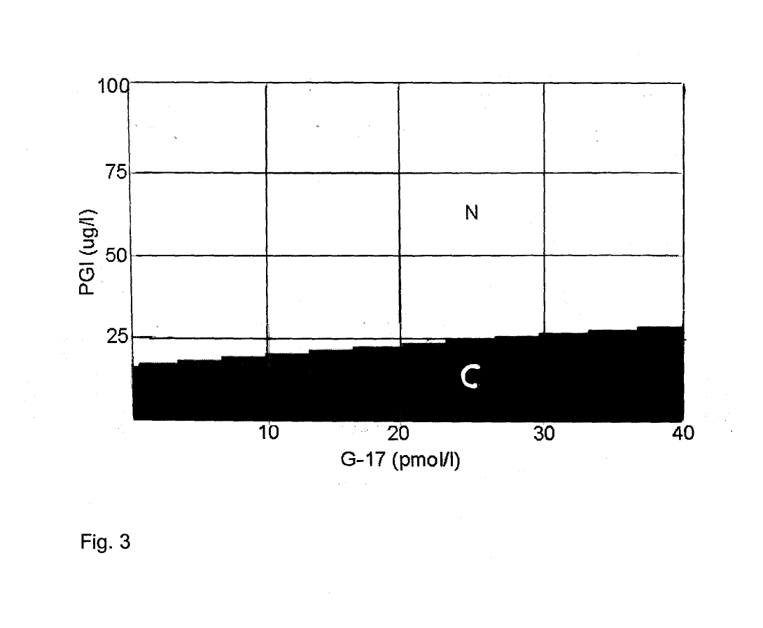

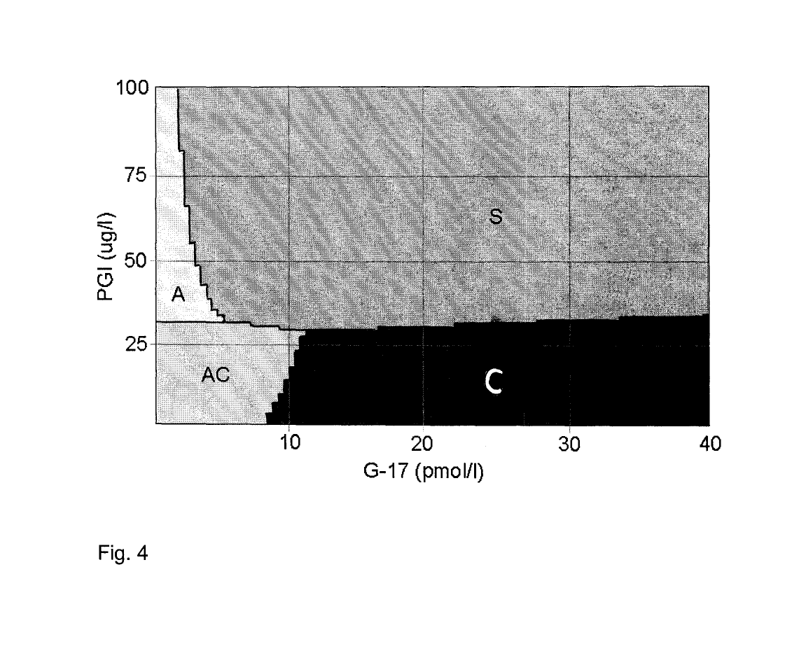

If the HP result (negative or positive) is known from serological or other tests, two maps, one for HP− (FIG. 3) and one for HP+ (FIG. 4) provides a practical aid for classification. In this case the axes are obviously PGI and G-17. In general, by presenting the most probable classes on a map provide not only a practical way for document form classification, but a visual aid when run and displayed on a data processing display e.g. when samples from different patient groups are (e.g. no smokers-smokers, women-men, treated-non treated) are plotted on the same map. Such a visual aid provides easy means to compare groups with each other.

1. Method for assessing or predicting the state of the gastric mucosa in a subject by determining, in said subject, the probability for the gastric mucosa belonging to at least one gastric mucosa class, the method comprising
measuring, from a sample of said subject, the pepsinogen I (PGI) and gastrin-17 (G-17) analyte concentrations, as well as determining the presence or concentration of a marker for Helicobacter pylori,
entering the data so obtained in a data processing system comprising an operating system, a database and means for transceiving and processing data, the said data processing system being adapted to determine the probability for the gastric mucosa belonging to the at least one gastric mucosa class, the gastric mucosa class being selected from the group of classes consisting of normal (N), antrum atrophy (A), antrum and corpus atrophy (AC), corpus atrophy (C) and superficial or non-atrophic gastritis (S), based on the data entered as well as on predefined clinical data in the database, the information so generated by the data processing system being indicative of the state of the gastric mucosa in said subject.

2. The method according to claim 1 for assessing a change in the state of the gastric mucosa, the method comprising repeating the determination of the probability for the at least one gastric mucosa class, and comparing the probabilities so obtained with the earlier determined probabilities in order to provide information relating to the change in the state of the gastric mucosa.

3. The method according to claim 1, wherein the predefined clinical data in the database comprises data obtained from a reference population group by gastroscopic study and determination of the PGI and G-17 analytes and Helicobacter pylori marker in said reference population group.

4. The method according to claim 1 wherein the probabilities are determined using a statistical method for calculation of the classification probabilities.

5. The method according to claim 4 wherein the statistical method for the calculation of the classification probabilities is a multinominal logistic regression method (MLR).

6. The method according to claim 1, comprising the further step of using the generated information for providing a diagnosis and/or a suggestion for further treatments or examinations.

7. The method according to claim 1, wherein the Helicobacter pylori marker is a Helicobacter pylori antibody, the concentration of which is measured from the sample.

8. The method according to claim 1, wherein the Helicobacter pylori marker is the Helicobacter pylori antigen, the presence of which is determined in the sample.

9. The method according to claim 1, wherein the gastrin value measured is the stimulated gastrin-17 value (G-17st), or both the gastrin-17 and the stimulated gastrin-17.

10. The method according to claim 1, wherein, in addition, the concentration of the analyte pepsinogen II (PGII) is measured, and the ratio PGI/PGII is used in the statistical calculation.

11. The method according to claim 1, wherein the analytes are measured from a body fluid, such as a serum whole blood, urine, saliva or lacrimal fluid sample, especially a serum sample.

12. The method according to claim 1, wherein the data processing means comprise a display, and the information generated is displayed on the display.

13. A kit comprising means for determining, from a sample, the pepsinogen I and gastrin-17 concentration, and the concentration or presence of a Helicobacter pylori marker, as well as a computer program product embodied on a computer readable medium and comprising computer code means adapted to determine a probability for a gastric mucosa class, the gastric mucosa class being selected from the group of classes consisting of normal (N), antrum atrophy (A), antrum and corpus atrophy (AC), corpus atrophy (C) and superficial or non-atrophic gastritis (S) based on measured values for said analytes and/or marker as well as a predefined clinical data in a database, and to provide information in response to said determination and optionally other entered data, when run on a computer.

14. The kit according to claim 13, wherein the predefined clinical data comprises data obtained from a reference population group by gastroscopic studies and determination of values for PGI and G-17 analytes and Helicobacter pylori marker from said reference population group.

15. A computer program product embodied on a computer readable medium and comprising computer code means adapted to determine a probability for a gastric mucosa class, the gastric mucosa class being selected from the group of classes consisting of normal (N), antrum atrophy (A), antrum and corpus atrophy (AC), corpus atrophy (C) and superficial or non-atrophic gastritis (S) based on measured values for the PGI and G-17 analytes and Helicobacter pylori marker, as well as a predefined clinical data in a database, and to provide information in response to said determination and optionally to other entered data, when run on a computer.
